(19) United States
(12) Patent Application Publication
(10) Pub. No.: US 2021/0206279 A1
(43) Pub. Date: Jul. 8, 2021

(54) CHARGING SCOOTERS WITHIN ELECTRIC SCOOTER DOCKING STATIONS

(71) Applicant: Neptune Scooters, San Carlos, CA (US)

(72) Inventors: Forrest Jean NORTH, San Carlos, CA (US); David Osman DOLUCA, San Carlos, CA (US)

(21) Appl. No.: 17/211,665

(22) Filed: Mar. 24, 2021

Related U.S. Application Data
(63) Continuation-in-part of application No. 16/994,162, filed on Aug. 14, 2020.
(60) Provisional application No. 62/993,912, filed on Mar. 24, 2020.
(60) Provisional application No. 62/993,912, filed on Mar. 24, 2020.
(60) Provisional application No. 62/888,316, filed on Aug. 16, 2019.

(51) Int. Cl. B60L 53/14; B60L 53/30; H02J 7/00

(52) U.S. Cl. CPC B60L 53/14; B60L 2200/24; H02J 7/0045; B60L 53/30

(57) ABSTRACT

An electric scooter docking station facilitates an electric scooter charging other electric scooters within the docking station. The docking station can identify scooters having excess charge, and, when they are docked, cause these scooters to charge other scooters via bus bars or other components of a docking station.

### CROSS REFERENCE TO RELATED APPLICATIONS

This application claims priority to U.S. Provisional Patent Application No. 62/993,912, filed on Mar. 24, 2020, entitled ELECTRIC SCOOTERS AND ASSOCIATED SYSTEMS, which is incorporated by reference in their entirety. This application is a continuation-in-part (CIP) of U.S. patent application Ser. No. 16/994,162, filed Aug. 14, 2020.

### BACKGROUND

There are many ways to get around a city. A person can walk, drive, travel by bus, tram, subway, taxi, or hire a car share service. A person can also rent or use various individual modes of transportation, such as mopeds, bikes (e.g., e-bikes or ebikes), scooters, skateboards (electric skateboards) and/or other micro-mobility vehicles or devices. For example, many cities provide residents and visitors with bike share and scooter share services, such as services that enable people to rent bikes or electric scooters when traveling short distances within a city.

While these services provide people with numerous benefits, current installations and provisioning of bike and scooter shares suffer from various drawbacks. For example, services that provide the docking of bikes can take up a large footprint within a city or neighborhood, such as in areas where any extra space can be utilized for parking, footpaths, and so on. As another example, services that provide dock-less bikes and scooters enable users to simply leave their rented bikes and scooters in the middle of sidewalks, in yards, and other undesirable locations. Further, the vehicles are often stolen or broken.

These and other drawbacks exist with respect to current electric scooter share services.

### BRIEF DESCRIPTION OF THE DRAWINGS

FIGS. 1A-1B are diagrams illustrating an electric scooter docking station.

FIGS. 2A-2D are diagrams illustrating an electric scooter docked within the electric scooter docking station.

FIGS. 2E-2G are diagrams illustrating a three-wheel electric scooter docked within an electric scooter docking station.

FIG. 3 is a diagram illustrating an electric scooter in contact with the electric scooter docking station.

FIGS. 4A-4C are diagrams illustrating contact components between an electric scooter and an electric scooter docking station.

FIG. 5 is a diagram illustrating an electric scooter with electrical and/or mechanical contact components.

FIGS. 6A-6D are diagrams illustrating components configured to de-couple the electrical and/or mechanical components of an electric scooter to a docking station.

FIG. 7 is a block diagram illustrating components of the electric scooter and the electric scooter docking station.

FIG. 8 is a diagram illustrating an electric scooter docking station with a Z-shaped exit section.

FIGS. 9A-9D are diagrams illustrating the dispensing of an electric scooter from the electric scooter docking station.

FIGS. 10A-10H are diagrams illustrating an electric scooter docking station having a vertical storage configuration.

FIG. 11 is a flow diagram illustrating a method for charging an electric scooter within a docking station.

FIG. 12 is a diagram illustrating charge balancing of electric scooters within a docking station.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

Various electric scooter docking stations are described herein. In some embodiments, the docking stations facilitate the collection, movement, and/or storage of electric scooters in a compact, elegant, and efficient configuration. For example, the docking stations can be configured to take advantage of the unique shape of a scooter, providing the storage and positioning of many scooters in a compact area. Also, the docking stations can be simple structures that facilitate the self-powered movement of electric scooters within a station.

Thus, in various implementations, the docking stations described herein are designed to enable self-propelled movement and docking of electric scooters within a station, while also recharging the scooters within the station. A docking station can also facilitate simple and efficient collection and entry of scooters into the station, as well as simple and efficient extraction or dispensing of scooters from the station.

For example, an electric scooter docking station can accommodate three-wheel scooters (e.g., scooters having two front wheels). For example, a docking station that dispenses electric scooters can include two upper channels, each configured to receive a front wheel of an electric scooter, a lower channel configured to receive a rear wheel of the electric scooter, where the two upper channels are positioned with respect to the lower channel in a configuration that stores electric scooters within the docking station at an angle with respect to the ground, and/or a charging rail that contacts a charging port of the electric scooter when the scooter is docked within the apparatus and provides charge to an electric battery of the electric scooter.

As another example, an electric scooter docking station facilitates an electric scooter charging other electric scooters within the docking station. The docking station can identify scooters having excess charge, and, when they are docked, cause these scooters to charge other scooters via bus bars or other components of a docking station.

In the following description, for the purposes of explanation, numerous specific details are set forth in order to provide a thorough understanding of implementations of the present technology. It will be apparent, however, to one skilled in the art that implementations of the present technology can be practiced without some of these specific details. The phrases “in some implementations,” “according to some implementations,” “in the implementations shown,” “in other implementations,” and the like generally mean the particular feature, structure, or characteristic following the phrase is included in at least one implementation of the present technology and can be included in more than one implementation. In addition, such phrases do not necessarily refer to the same implementations or different implementations.

### Examples of Electric Scooter Docking Stations

Several implementations of the docking stations are discussed below in more detail with reference to the figures. However, a docking station, as described herein, can include one or more rails to facilitate collection of scooters, as well as the movement of scooters into, within, and out of a docking station. Further, a docking station includes a charging connector or other similar component which, when contacted by a similar component of a scooter (e.g., a charging port integrated with the scooter), charges an electric battery of the scooter when docked or contained in the docking station.

The docking station can also include various computing systems, such as a computing system that performs various actions, method, and/or techniques associated with scooters within or external to a docking station. The computing systems can interact with various external or networked computing systems, such as systems provided by remote or cloud services or locations. Further, the computing system of a docking station can wirelessly communicate with one or more docked electric scooters over various protocols, including Wi-Fi, Bluetooth, and other wireless protocols, near field communication protocols (such as when a scooter is docked), and so on.

Also, in some embodiments, communications between the docking stations and various components (or associated scooters) may be performed over wired connections, including various power lines or connections. Further, as described herein, in some cases, the docking stations can be simple structures that are configured to docking and store electric scooters, but provide no power, charging, or communications functions for the electric scooters themselves.

Further, an electric scooter, as described herein, is generally a powered stand-up scooter, propelled by an electric motor. Electric scooters can also be referred to as electric kick scooters, e-scooters, motorized scooters, and so on. Typically, an electric scooter includes two (or more) small wheels (e.g., hard or solid tires, air tires, foam filled tires), a foldable or non-foldable steering tube, a chassis having a deck to stand on, a down tube connected to the head tube inside of which turns the steering tube connected to a stem attached to handlebars. In addition, the electric scooter can include fenders, trailer hitches, brakes, lights, and other accessories or components.

The components of an electric scooter can include a transmission or drive system, a control system, a braking system, a suspension, a battery, and an electric motor. The electric scooter may also include various computing systems and components, such as the various computing systems described herein, GPS or positioning systems, communication components, and so on. For example, an electric scooter can include computing systems and identification components that facilitate or enable the electric scooter as an Internet of Things (e.g., IoT) device networked to other scooters and one or more control or communication systems.

The techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

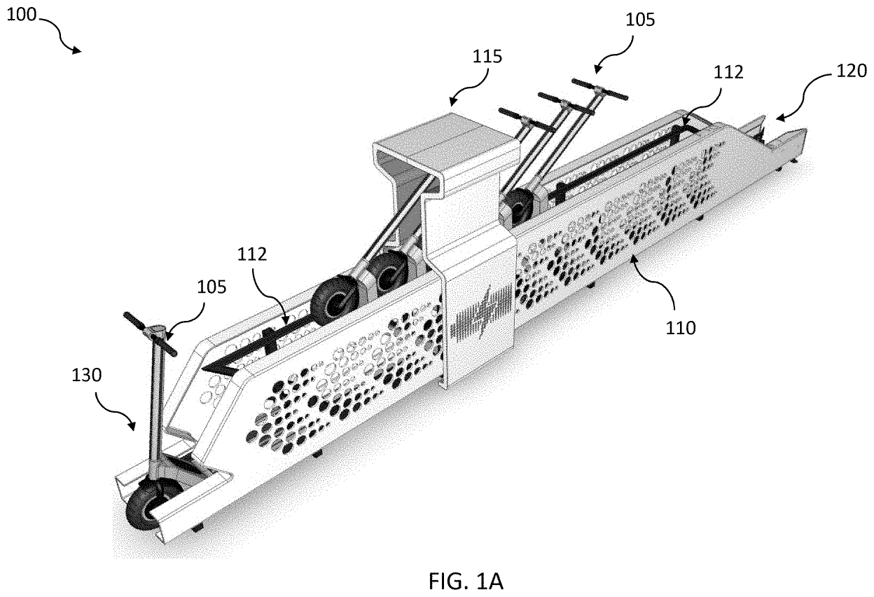

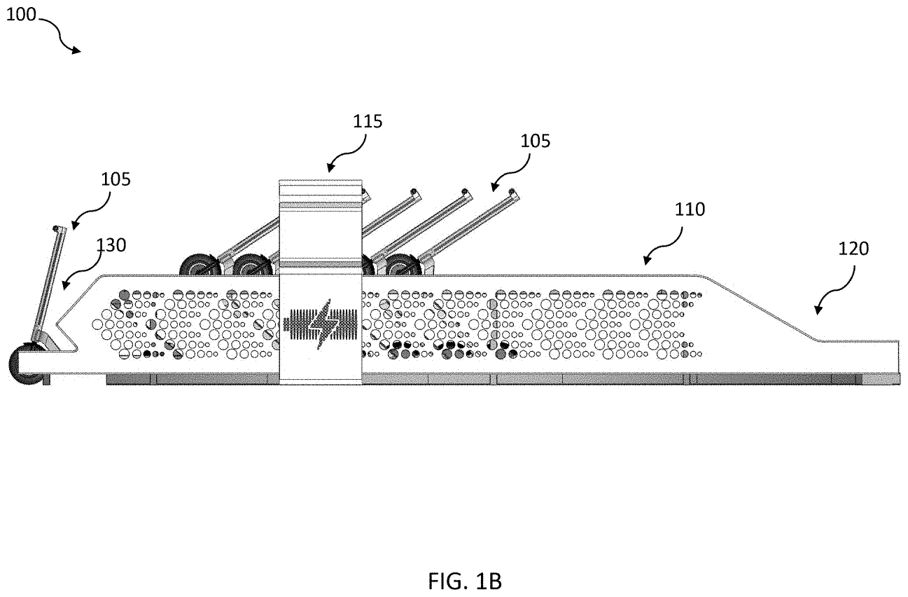

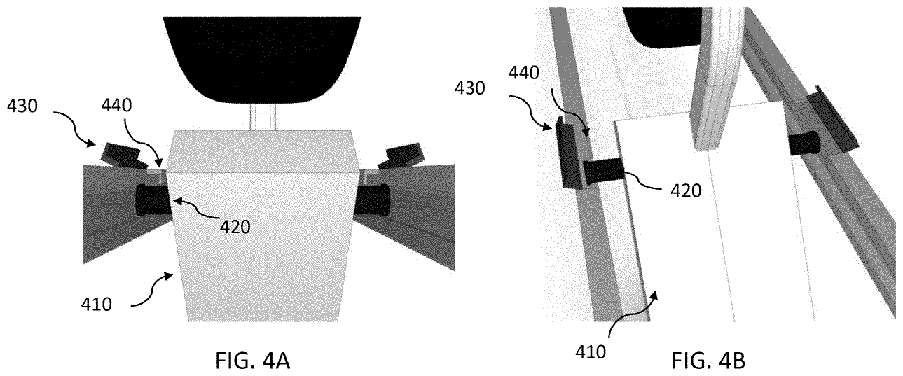

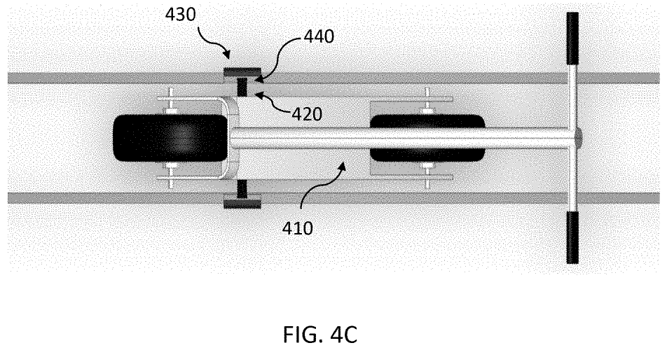

As described herein, the technology includes various docking station apparatuses and configurations. While depicted herein as different version of a docking station, in some embodiments, components from different versions may be integrated together to realize other configurations for docking electric scooters. As an example, FIGS. 1 and 4A-4C depict a first version of an electric scooter docking station 100.

FIGS. 1A-1B are diagrams illustrating an electric scooter docking station 100. The docking station 100 includes a housing 110 configured to dock, store, or contain electric scooters 105. For example, as will be described herein, the housing 110 includes rails, channels, or other support components 112 configured to store multiple scooters at an angle with respect to the ground, such as at an angle that is 30-60 degrees from a horizontal axis defined by the ground.

The docking station 100 includes an entry section 120, which receives the electric scooters 105 into the docking station 100, as well as an exit section 130, which facilitates the exit or dispensing of the electric scooters 105 from the docking station 100. For example, the exit section 130 can be configured in various geometries (e.g., a Z-shape, as described herein) in order to guide the docked scooters 105 from the angled, docked, position to a horizontal position (e.g., the position via which the scooters 105 enter the docking station 100) when dispensed to a user from the docking station 100.

The docking station 100 can include other components, as described herein, including components that facilitate the receipt of payment information, user information, or other information communicated to the docking station 100 from a user. Further, given the use of electric scooters 105 by many different users, the docking station 100 can include sanitation or cleaning components 115.

For example, the docking station 100 can include various sanitization or cleansing facilities or areas. The docking station 100 can include an area or component where scooter handles pass through (e.g., either at the beginning or end of the station), and disinfect or clean the handles with mechanical, chemical and/or UV light before the next person uses the scooter. The docking station 100 can also use similar components when dispending helmets or other shared equipment.

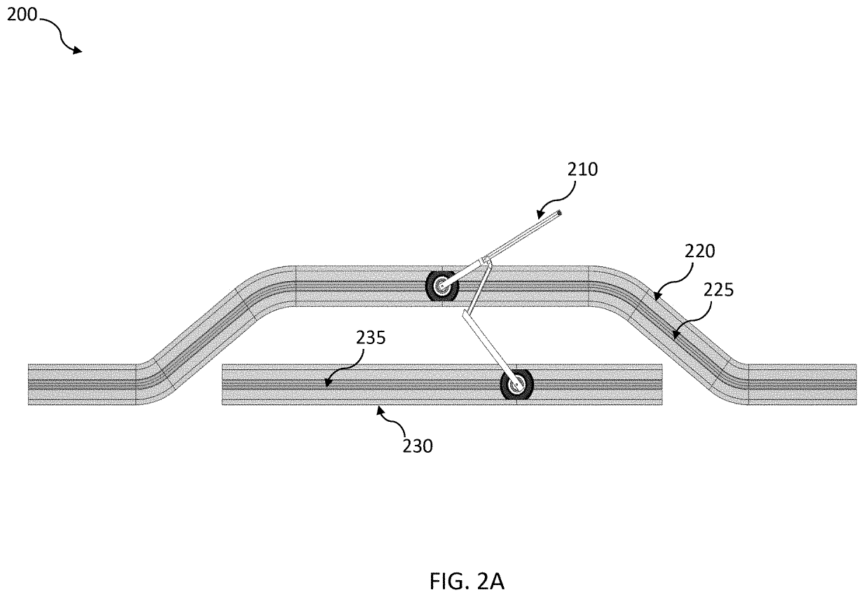

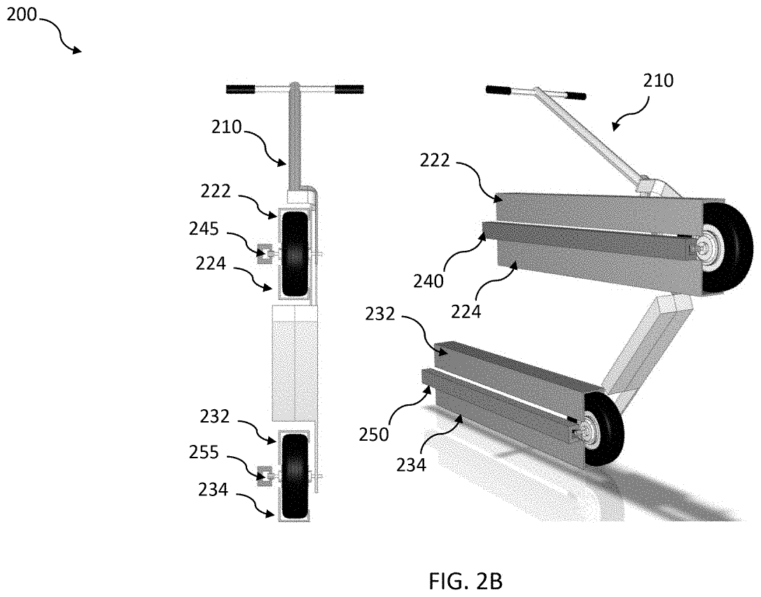

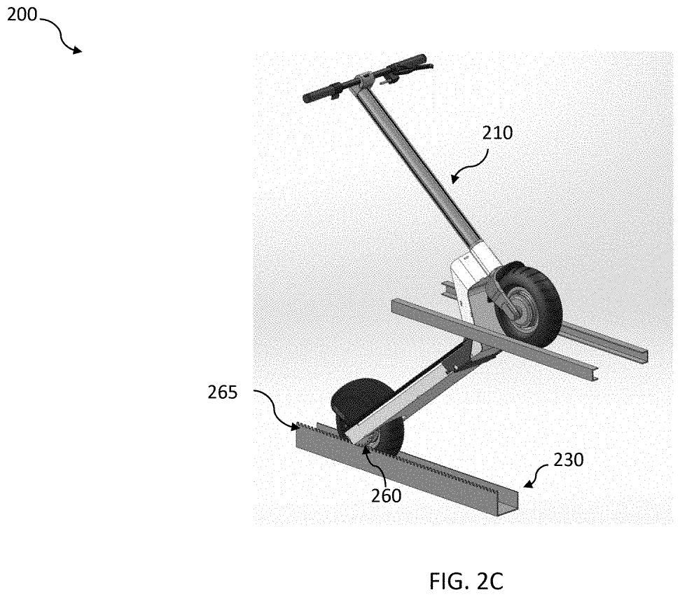

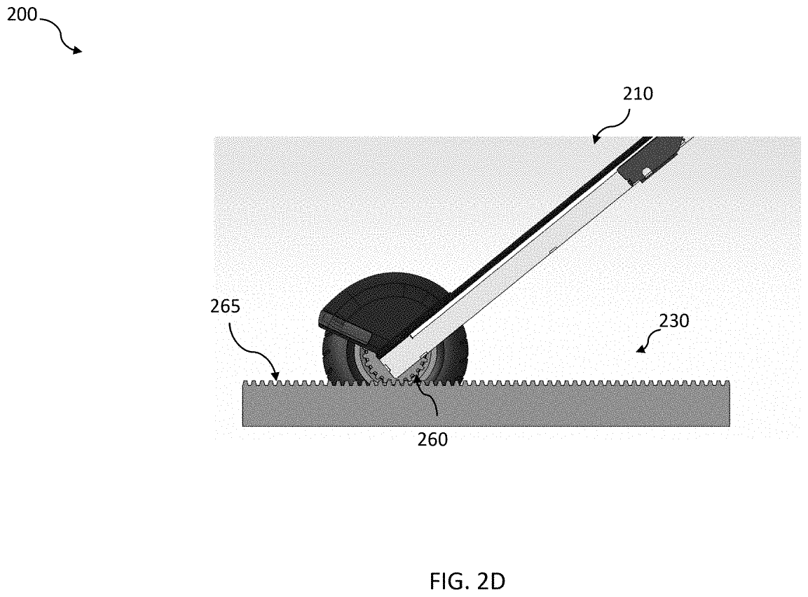

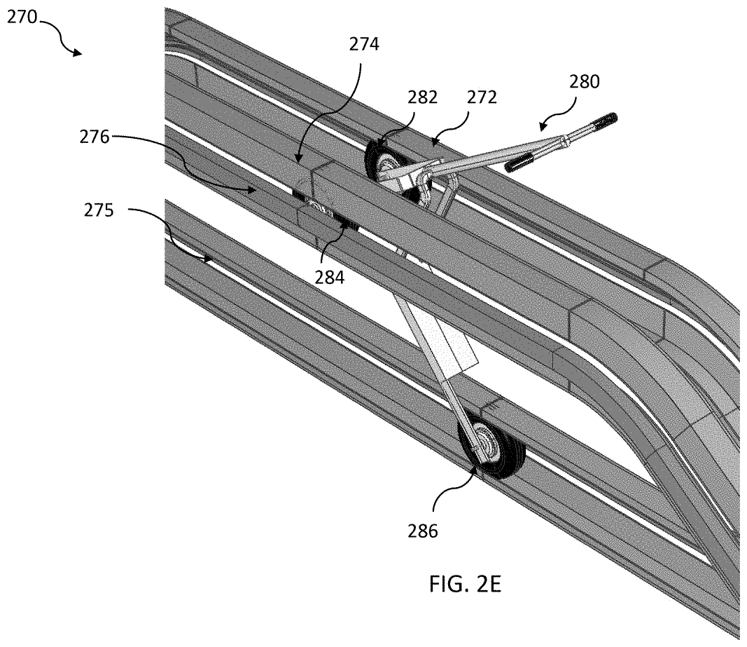

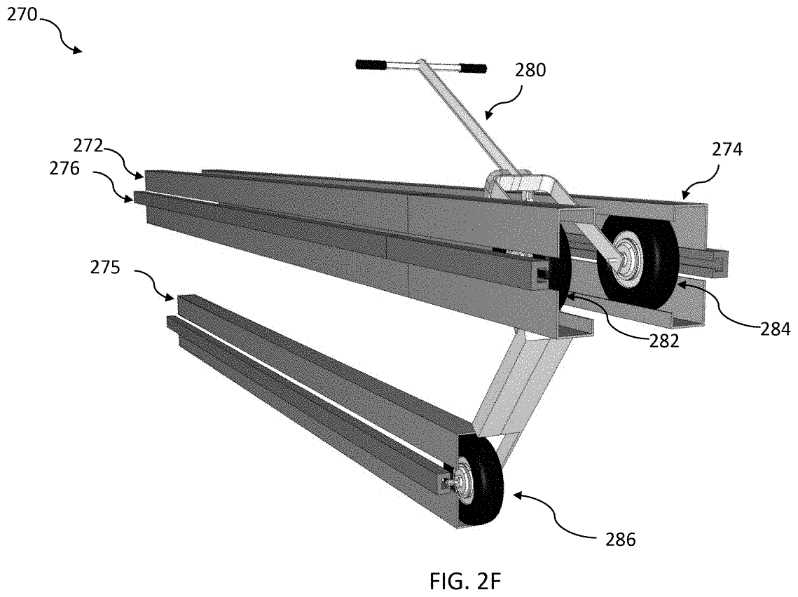

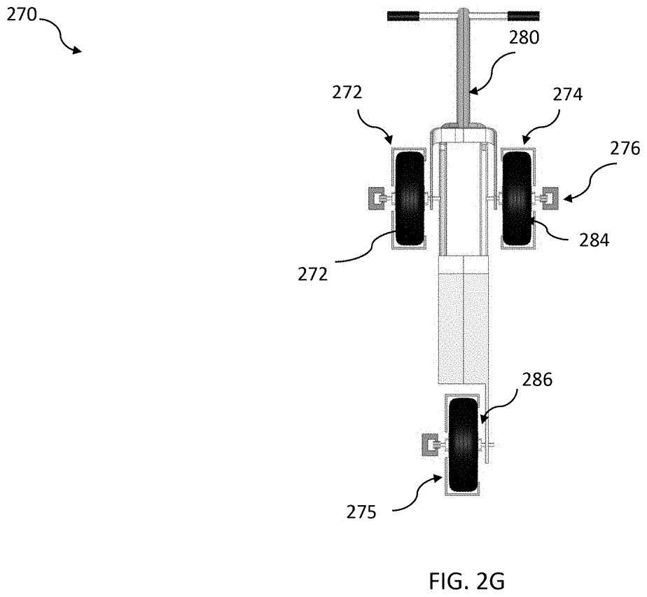

FIGS. 2A-2B are diagrams illustrating an electric scooter docked within an electric scooter docking station.

As shown in FIG. 2A, the docking station 200 stores an electric scooter 210 docked within the station 200. The station 200 includes a front wheel channel 220, which receives a front wheel of the scooter 210. The docking station 200 also includes a rear wheel channel 230, which receives a rear wheel of the scooter 210. The configuration of the channels 220, 230 (or, alternatively, rails) causes the front wheel of the scooter 210 to lift up and sit in an elevated position within the station 200 and when advancing through the station 200 (e.g., from an entry to an exit of the station 200). Thus, the electric scooter 210 is docked within the docking station 200 at an angle with respect to the ground.

The raised position can optimize the available space within the docking station 200, as the station can facilitate many scooters per linear foot (with respect to positioning scooters end to end). In some embodiments, various different combinations and/or geometries of lower and/or upper channels (e.g., real wheel and/or front wheel channels) enable the efficiency and/or optimization of storage of scooters. For example, the station may include only the upper channel 220, the lower channel 230, or a combination of both channels. Further, in some cases only certain sections or portions of a station include channels that receive scooters and/or wheels of scooters.

The channels can receive the electric scooter 210 such that scooter propels itself within the station 100 (e.g., via the channels 220, 230) via its electric motors, as the channels (or rails) ensure the lateral stability of the scooter 210 as the scooter 210 moves within the docking station 200. Further, the configuration of the channels or rails, such as via ramps or other undulations, are designed to control the speed and/or movement of the scooter 210 as it traverses the station 200.

In some embodiments, the docking station 200 includes a battery charging component for adapted scooters (e.g., scooters with contactable charging ports). The station 200 can include a charging channel, connector, or component. For example, the front wheel channel 220 can include a charging connector 225, and the rear wheel channel 230 can include a charging connector 235. In some cases, the station 200 includes one charging connector or rail, which charges a battery of the scooter 210 when in contact with a charging port of the scooter 210.

FIG. 2B depicts additional details of the docking station 200. The front wheel channel 220 includes a front wheel channel upper component 222, a front wheel channel lower component 224, and a front wheel channel charging connector 240, which is positioned to make contact with a scooter charging port 245 when the scooter 210 is docked within the station 100.

The rear wheel channel 230 includes a real wheel channel upper component 232, a rear wheel channel lower component 234, and a rear wheel channel charging connector 250, which is positioned to make contact with a scooter charging port 255 when the scooter 210 is docked within the station 200. As described herein, the docking station 200 can include the charging connectors within both channels and/or within one of the channels.

In some cases, the rear wheel channel 230 (e.g., the lower channel) can include various components or materials to provide traction or friction to the rear wheel of a scooter as it moves through the channel 230. For example, the channel 230 (or in some cases, the front wheel channel 220) can include grit paper or coating, grooves or holes, expanded metal, a specific mating shape that matches the scooter tires, and/or a rotating disc, cog or gear shape positioned on the side of the wheel or cast into the tire to aid in providing traction for the wheel motor to be able to drive the scooter through the docking station.

FIGS. 2C-2D depict a scooter traveling through a docking station with the assistance of a gear 260 and associated channel shape 265 to receive the gear 260. As shown, the scooter 210 includes the gear 260, which, when engaged with the sawtooth shape 265 of the channel, drives through the lower, or rear wheel, channel 230 as it moves through the docking station.

As described herein, in some embodiments, a docking station includes multiple rails to dock, store, collect, or otherwise accommodate three-wheel scooters, such as scooters having two front wheels. FIGS. 2E-2G depicts a docking station 270 configured to dock or store a three-wheel electric scooter 280. The docking station 270 includes two front wheel channels 272, 274, which receive front wheels 282, 284 of the electric scooter 280. One or both of the channels 272, 274, can include a charging rail 276, which, as described herein, is configured to charge the electric scooter 280 when the scooter travels within the channels 272, 274. The docking station 270 also includes a real wheel channel 275, which is configured to receive a rear wheel 286 of the electric scooter 280.

The front wheel channels 272, 274 can include various components described herein with respect to single wheel channels, including charging rails. Further, the front wheel channels 272, 274 can be configured into various geometries, as described herein, to accommodate different wheel sizes, different scooter widths, charging ports or posts, and so on.

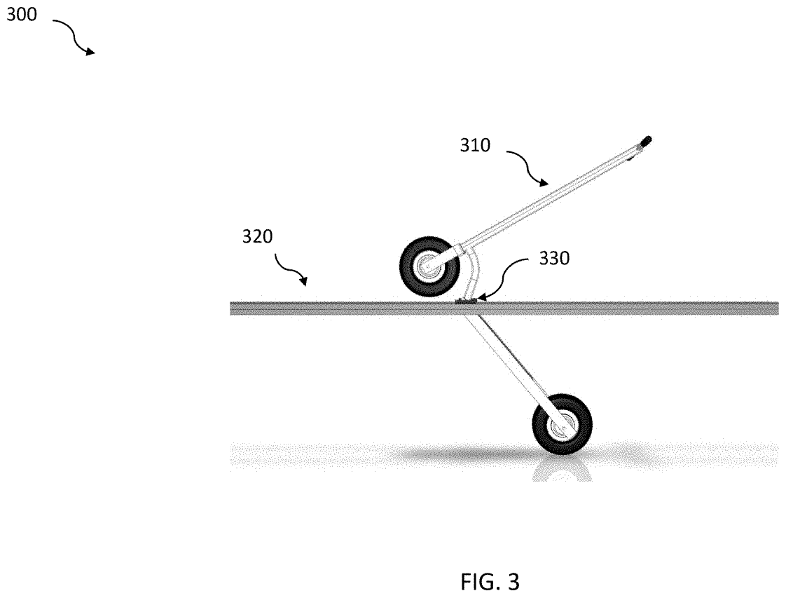

FIG. 3 is a diagram illustrating an electric scooter in contact with an electric scooter docking station 300. The docking station supports an electric scooter 310 via one or more channels or rails 320. In order to facilitate removal of the scooter 310 from the station 300, the rails 320 include rail openings 330, which enable the scooter 310 to move up and out of the station 300 (e.g., out of the rail 320). As depicted, the electric scooter 310 includes guiding pegs, coupled to the rails 320, which allows the electric scooter 310 to move along the rails 320 and travel through the docking station 300.

FIGS. 4A-4C present additional details, including the depiction of contact components between the electric scooter and the electric scooter docking station. An electric scooter 410 having fixed or rotating mechanical guiding pegs 420 (which can also be charging ports or electrical contacts, as described herein) is stored and/or racked within the channels or rails, such as rails 320. At certain points along the rails, openings 440 with associated covers 430 are positioned.

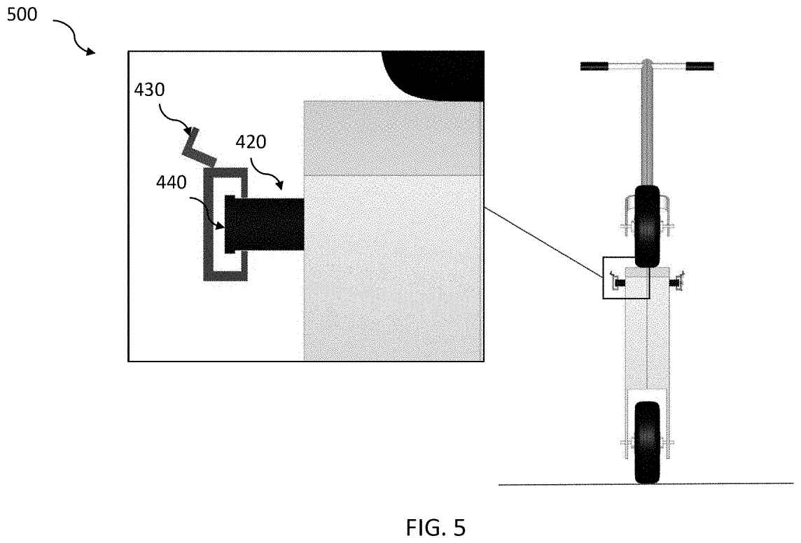

FIG. 5 is a diagram illustrating an electric scooter with electrical contact components 500. As shown, the electric scooter includes guiding pegs 420. Once the scooter 410 is in position, the covers 430 are rotated (or removed or slid), and the scooter 410 can be lifted out of the station 300 via the openings 440 (e.g., the guiding pegs travel up and out of the openings 1440).

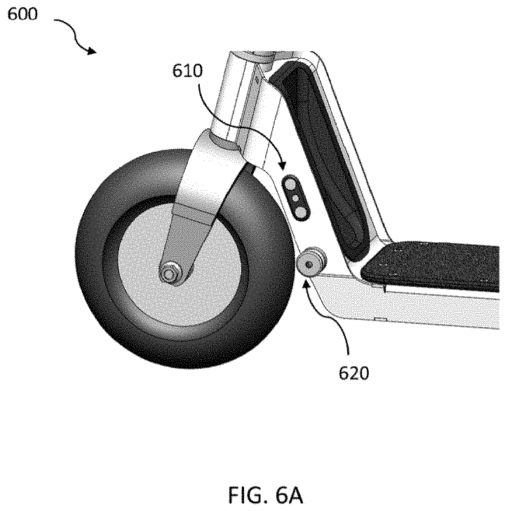

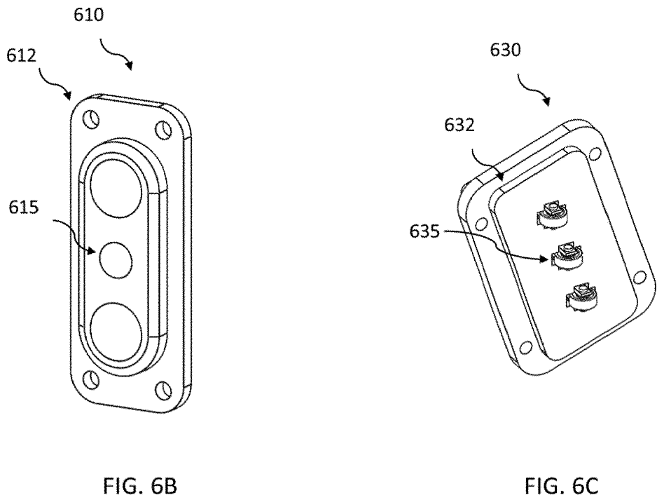

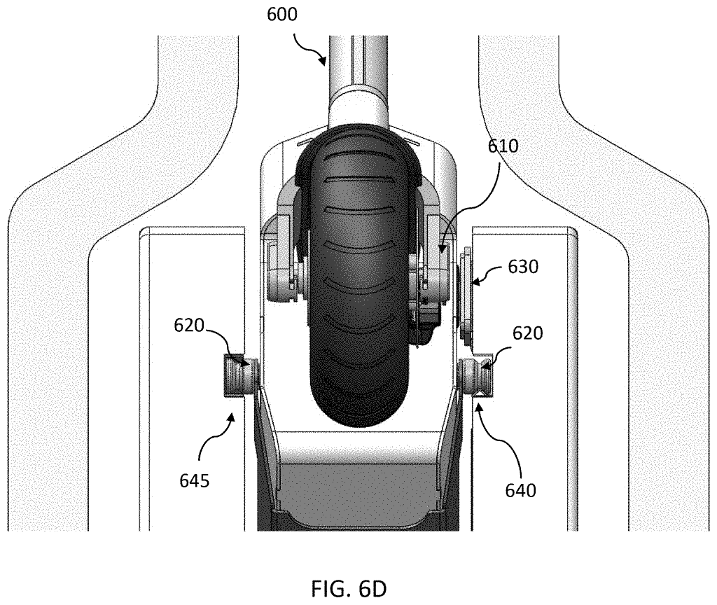

Further, the guiding pegs 420 (or other components proximate to the pegs), being in contact with the rails (or electrical contacts with the rails), can facilitate the movement of the electric scooter, as well as the charging of the battery of the scooter, when docked within the docking station 300. FIGS. 6A-6D are diagrams illustrating components configured to couple an electric scooter to a docking station.

FIG. 6A depicts an electric scooter 600 having guiding pegs 620 and contact pads 610 that facilitate communication and/or electrical charge transfer. The guiding pegs 620, as described herein, act to position the scooter within a docking station (within the rails) and guide the scooter through the docking station (e.g., from entry to exit). The contact pad 610, which is positioned proximate to the guiding peg 620 (e.g., on or along the chassis or steering tube), enables the electric scooter 600 to electrically couple to a mating contact on a docking station and receive charge from the docking station. As described herein, the mating contacts can be rails, fixed contacts, sliding contacts, rolling contacts, and so on.

FIG. 6B depicts an example contact pad 610. The contact pad 610 includes a base 612 that facilitates attachment to the electric scooter (e.g., on a side surface of the chassis), and one or more contact points 615 formed of a conductive material (e.g., copper, nickel, or other metals or alloys) mounted to or bonded to the base 612. The contact points 615 facilitate the transfer of current to the electric scooter, such as from electric components of the docking station (e.g., positioned on the rail).

FIG. 6C depicts an example mating contact plunger 630 provided by or positioned on the rail of a docking station. The contact plunger 630 includes a base 632 configured to attach the contact plunger 630 to a rail of the docking station. Further, the contact plunger 630 includes rolling contacts 635, which are adapted to make contact with the contact points 615 of the electric scooter 600 when the scooter 600 is positioned within the rail of the docking station. Thus, the rolling contacts 635, made from various conductive materials (e.g., metals or alloys), facilitate the transfer of current or charge from the docking station to the electric scooter 600 when in contact with the contact points 615 of the contact pad 610.

As described herein, the docking station may include rails having certain shapes that facilitate the positioning of the electric scooter 600 within the docking station such that the station restricts the scooter 600 from moving laterally when docked and in electrical contact with the rail or other contacts. FIG. 6D depicts the electric scooter 600 positioned within the rail and in contact with the docking station.

As shown, the contact pad 610 of the scooter 600 is coupled to the contact plunger 630 of the docking station. Further, the guiding pegs 620 of the scooter 600 are positioned within two rails 640, 645. The rail 640 includes a V-shaped groove, which matches a shape or contour of the mounting peg 620. Thus, when the peg 620 is positioned within the rail 640 such that the V-shape aligns with a matching portion of the peg 620, the peg 620 is prevented from moving laterally within the rail, and the scooter 600 is likewise prevented from moving laterally within the docking station (and possibly losing contact with the contact plunger 630 of the rail).

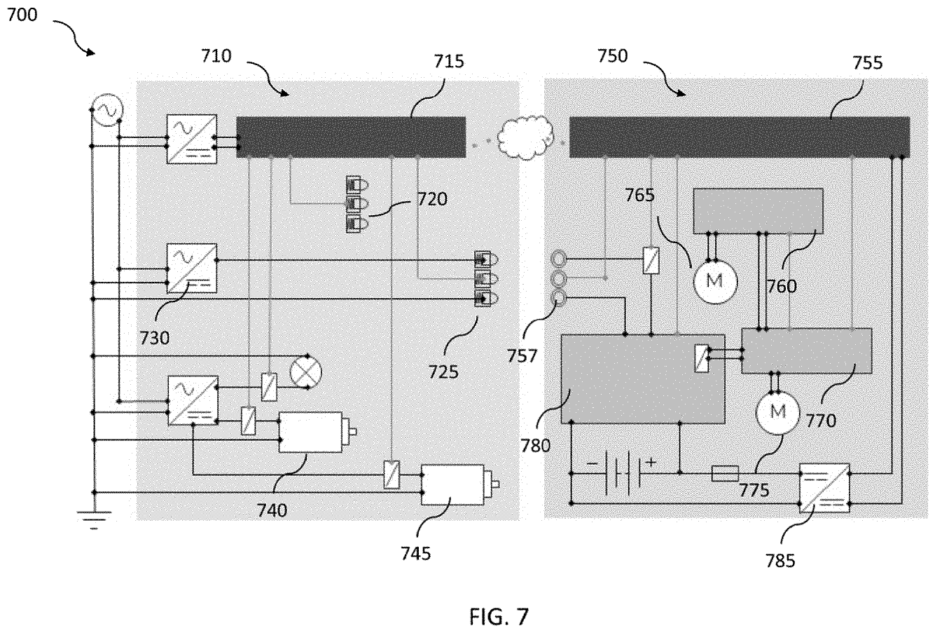

As described herein, the docking station can transfer charge to the electric scooter 600 when the scooter 600 is electrically coupled to the docking station. FIG. 7 depicts system level components 700 of the electric scooter 600 and the electric scooter docking station that facilitate the transfer of current between the docking station and the scooter 600.

The docking station 710 includes a management system (VMS) 715 or other similar control unit, which controls and manages the functions of the docking station 710. For example, the VMS 710 controls operations in response to signal received from an entry sensor 720, which detects the entry of scooters into the docking station. Further, the VMS 715 can interact with contact plungers 725 to provide or transfer charge to the scooters, as well as batteries and charging devices 730, an entry solenoid 740 that controls operations of the entry section of the station, an exit solenoid 745 that controls operations of the exit section of the station, and other electrical units or devices.

The electric scooter 750 likewise includes a vehicle management system 755, similar to VMS 715, which acts as the controller for the electric scooter 750. The VMS 755 can control or manage propulsion of the scooter, a battery or battery management system, on-board chargers, and other electrical units or devices.

For example, the scooter 750 includes contact pads 757, as described herein, which receive charge and communication (e.g., data, signals, or information) from the docking station. The scooter also includes multiple motor controllers 760, 770, which control multiple motors 765, 775 (e.g., for each wheel) in response to instructions provided by the VMS 755. A battery management system (BMS) 780 controls an associated rechargeable battery 785, which powers the motor controllers 760, 770, and motors 765, 775. The BMS 780 operates to monitor the charge state of the battery, as well as control the use of the battery to maintain the life of the battery and efficiently charge and discharge the battery 785.

In addition, as described herein, communication such as data or information exchange may occur between the docking station 710 and the electric scooter 750 via a wireless local connection, a cellular connection, Wi-Fi, Bluetooth, or via contacts that are part of the electrical recharging systems of the docking station 710.

Thus, as described herein, the electric scooter 750, when electrically coupled to the docking station 710, can receive the transfer of current from the docking station and charge its batteries when docked within the station.

Other embodiments of the docking stations described herein facilitate various actions performed by the docking stations and/or docked scooters. For example, when a pair of charging posts on an electric scooter slide along a pair of electrified rails, the scooter can determine how far it travels along the rails. The station can provide a series of contact segments, which have a known, predefined length. For example, for the sections of rail between contact segments, there is no electrical connection between the rails and the scooter charging posts. As the scooter travels along the rails, the charging posts make contact with the different contact segments and count the number of times that the posts lose electrical contact with the rail and come back into contact. Because the segments have a known, predefined length, the scooter can calculate how far it has travelled down the rail and determine its position within the station.

Further, while charging posts and pegs are described herein, in some cases, the handlebars of the electric scooters may include and/or act like the charging pegs, and directly contact conductive rails within a docking station. Thus, a rail charging interface within a channel or other component of a docking station can be configured into various shapes, positions, or designs, in order to make contact with a charging peg or post of a scooter, regardless of whether the charging post or peg is a separate component, part of the handle bars of the scooter, part of a down tube of a scooter, part of a fork of a scooter, part of a chassis of a scooter, and so on.

In addition, the docking station, in some cases, can include jigs or hooks that are attached to the rails or channels and slide along the rails or channels and contact the scooter, providing mechanical positioning, charging, and/or communication functions (either wirelessly or via direct contact with the electric scooter, as described herein).

As another example, in some embodiments, the electric scooter includes a pair of charging/guiding posts or pegs, which can include a conductive electrical surface for charging, and a mechanical/structural surface for guiding. A docking station can provide rails that include a low-friction rub strip and an electrical bus bar. Thus, each rail contacts a charging/guiding post on a scooter, providing physical guidance and alignment through the dock, and electrical current for battery charging, as described herein.

In some embodiments, terminal ends of a rail or channel can be electrically isolated from the charging portion of the rail. These rail sections can then be energized by a scooter using its onboard power. When energized, these rail sections provide power to ancillary functions of the dock, such as dock identification, communication, data storage (e.g., storing information about how many scooters have entered and exited the dock), and actuation (e.g., moving the location of a locking pin so that a scooter may be removed from the dock). The computing systems described herein can facilitate performing some or all of these functions.

In some cases, a constant or time-varying controlled current circuit is powered by a scooter's battery (and where the precise current is measured by the scooter's electronics over time). The numerical value of the current encodes information used by the scooter's electronics to determine factors such as the presence of a dock, identification of a dock, diagnostic information, and other information.

Further, in some cases, many or multiple electric battery-powered scooters are parked or stored in a docking station. As described herein, the docking station can include bus bars that are in electrical contact with each scooter's battery charging electronics. The charging electronics include voltage converters to decrease battery voltage to a safe voltage on the dock bus bars. The scooters in a dock communicate via power line or wireless components to negotiate charge balancing from scooters with excess battery charge to scooters with low battery charge. Thus, scooters with excess charge can supply current to the dock bus bars, and scooters with low battery charge use that current to charge their batteries.

As described herein, the docking station, such as docking station 100 or 200, includes a Z-shaped exit section or ramp, which enables the dispending of scooters from the docking station without damaging the scooters, even when the scooters are stored in various angular or vertical arrangements within the docking station.

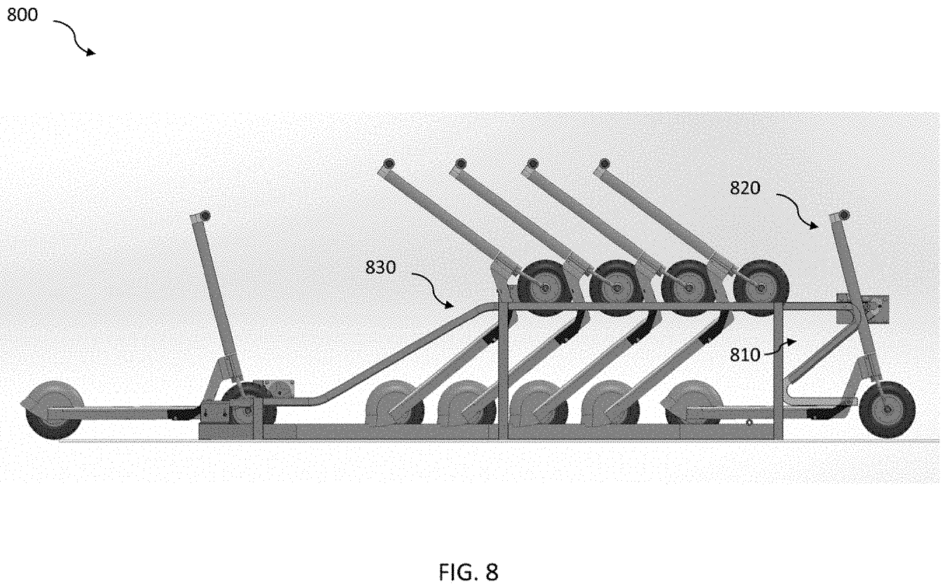

FIG. 8 is a diagram illustrating an electric scooter docking station 800 with a Z-shaped exit section. As depicted, the docking station 800 includes a Z-shaped exit ramp 810, which facilitates a smooth exiting of scooters from station 800 in compact- and space-saving configurations. An electric scooter 820 moves from the main housing area 830 to the exit section 810 of the station, travels down the Z-shaped section, and is disposed parallel to the ground and ready to be dispensed to a user.

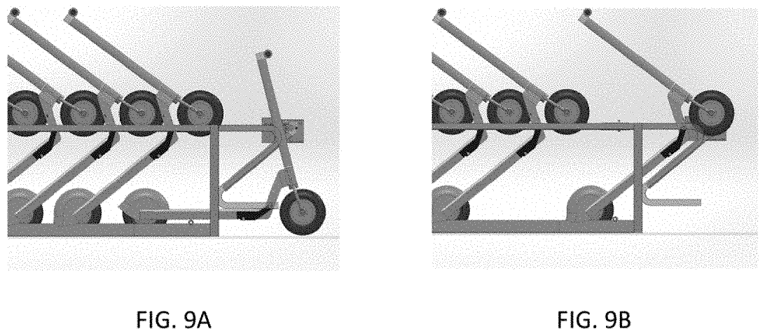

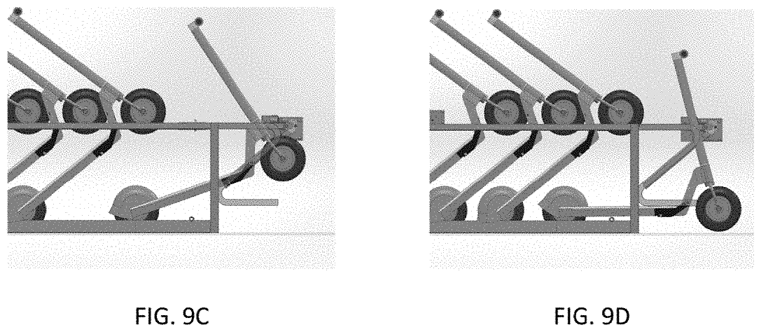

FIGS. 9A-9D illustrate operation of the Z-shaped exit ramp 810. As shown in FIG. 9A, a first scooter is positioned to exit the ramp 810. Other scooters docked in the station are in line and charging before exiting the station. Next, as depicted in FIG. 9B, after the first scooter is taken from the station, the next scooter moves to the front of the ramp 810 (at the top of the “Z”). In FIG. 9C, the scooter travels down the Z shape of the ramp 810 (depicted as a backwards Z), with the rear motor of the scooter regulating the movement so the scooter smoothly travels down the Z shape of the ramp 810. Finally, in FIG. 9D, a scooter exits (is taken by a rider), and the other scooters move forward, while continuing their charging operations, as described herein.

Of course, the docking stations described herein can include other exit (or entry) sections or components.

### Examples of Alternative Electric Scooter Docking Station Configurations

As described herein, the docking stations can be configured to store electric scooters in a variety of ways, such as vertically, horizontally, front to back, side by side, and so on. For example, the electric scooters 210 can operate such that the wheels provide opposing forces to one another, increasing a level of friction and grip between the wheels and the channels. In such cases, the docking station, via the rails, can facilitate the movement of the scooter 210 up or down vertically within a station. In such cases, the scooter 210 controls the torque applied to the wheels (via internal wheel motors) to adjust the grip to the inside of a rail, channel, or other component. The scooter 210, therefore, can effectively climb and move within the station, via an x-axis, y-axis, z-axis, or various angles, as it moves along within the station.

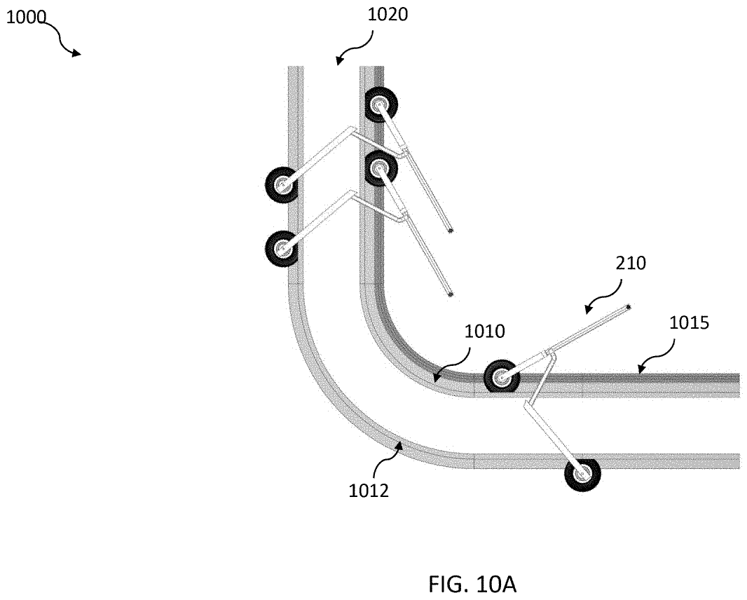

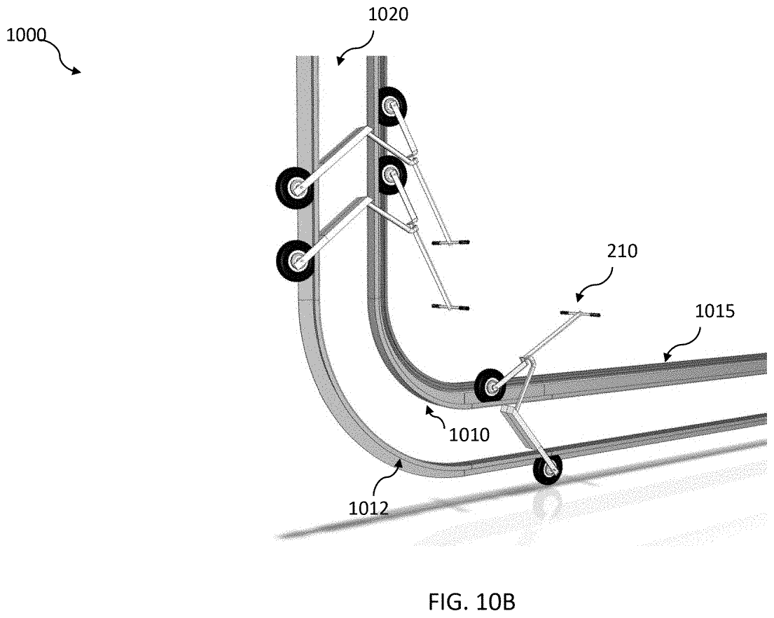

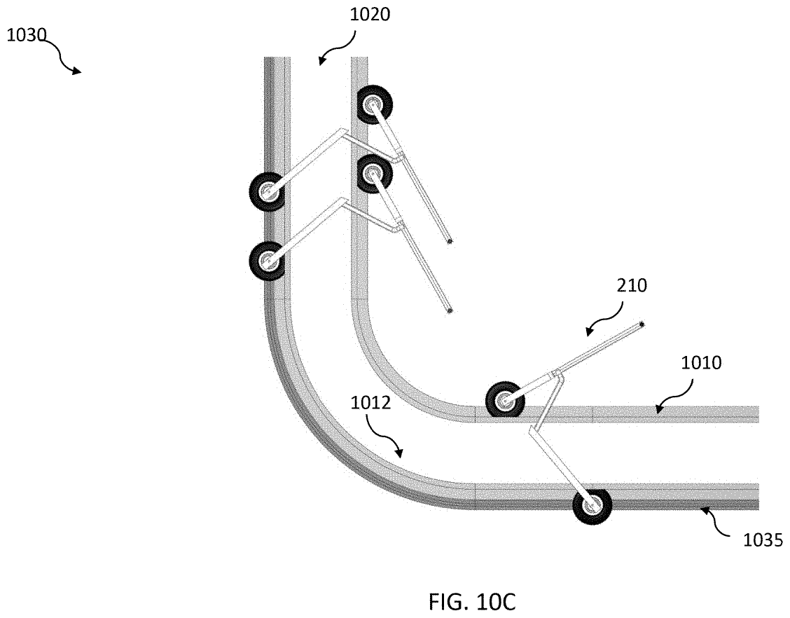

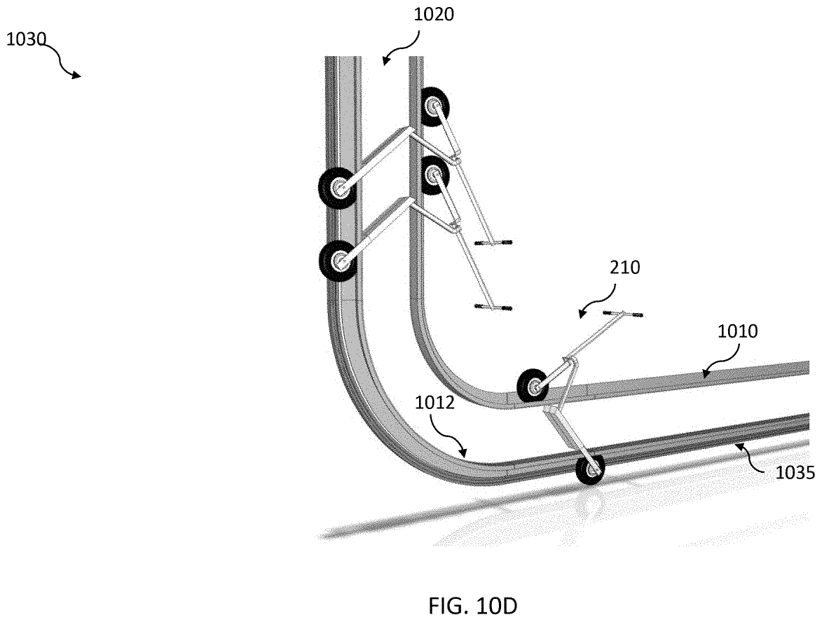

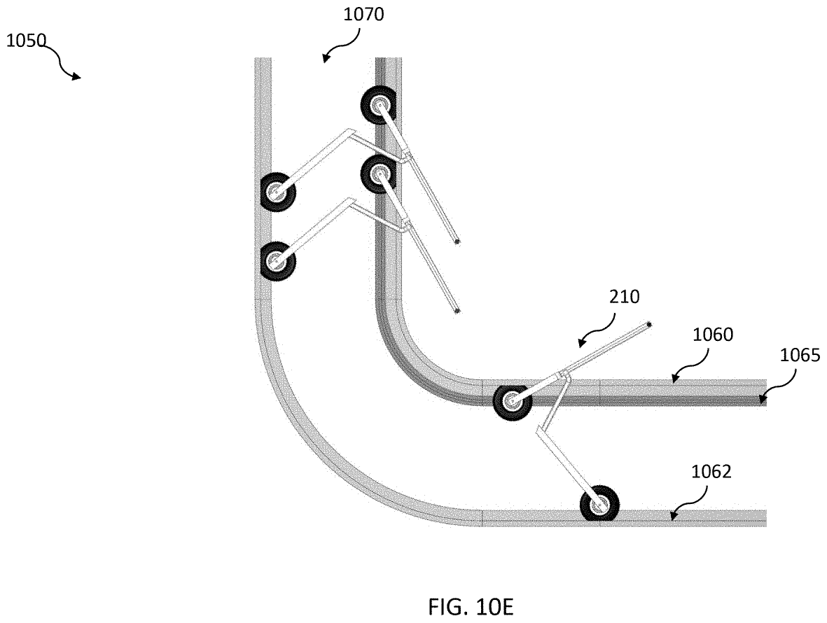

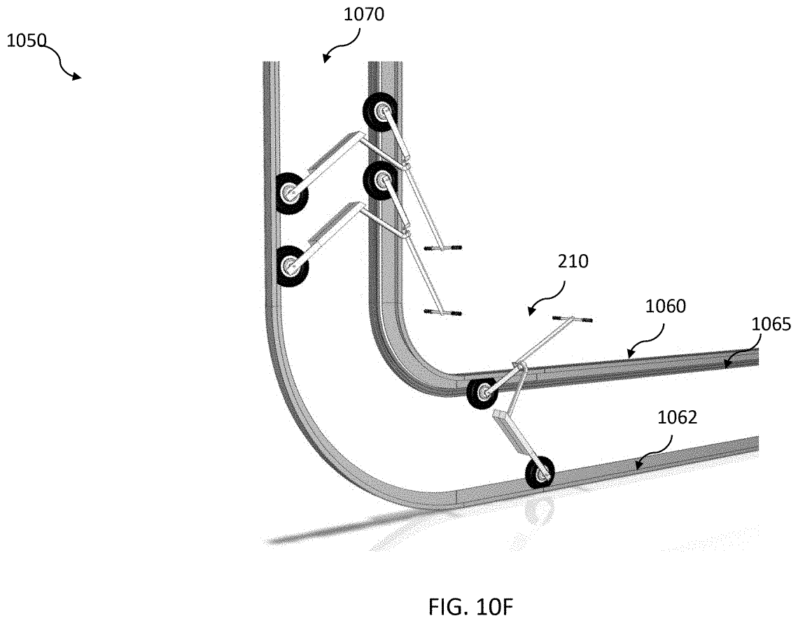

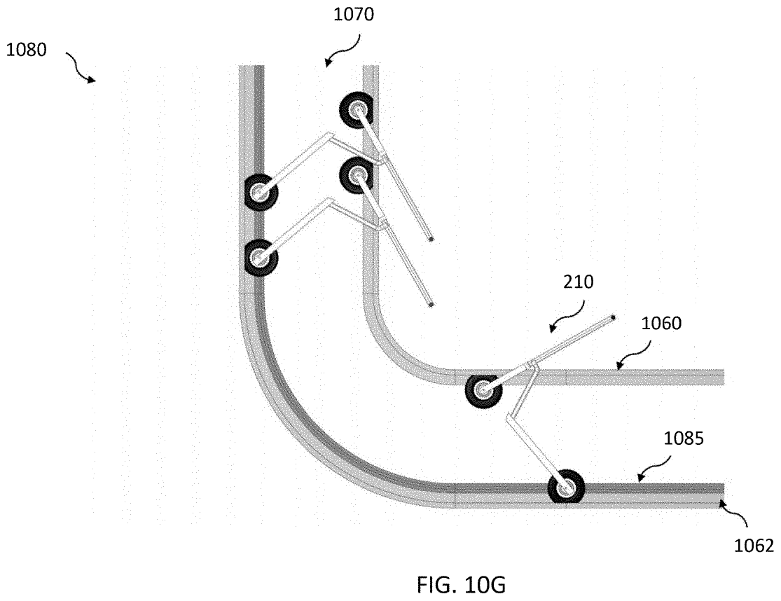

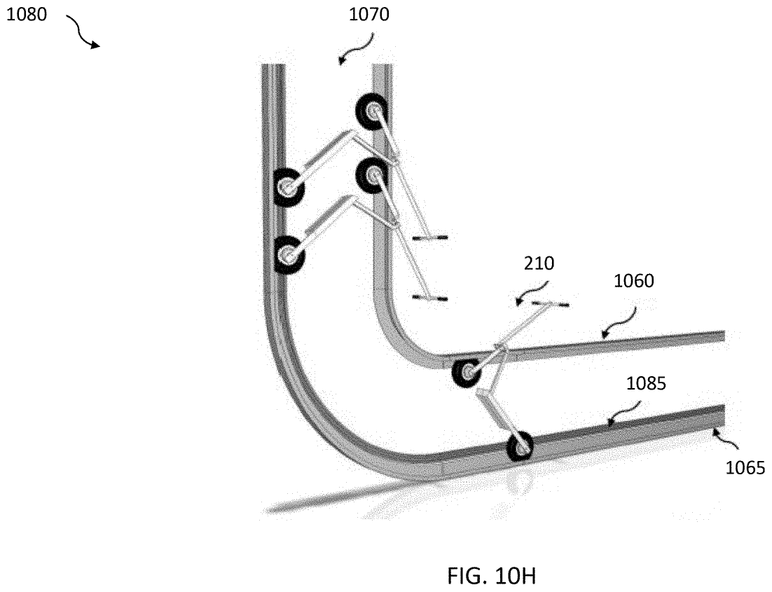

FIGS. 10A-10H are diagrams illustrating an electric scooter docking station having a vertical storage configuration. For example, the scooter 210 can move through and up the rails of the docking stations, such that they are docked on top of one another in a vertical column of scooters.

FIGS. 10A and 10B depict a rail section 1000 having an inner wheel track 1010 for an upper channel, as well as an inner wheel track 1012 for a lower channel. The inner wheel track 1010 of the upper channel also includes a front wheel charging port 1015 or connector, which charges the scooter 210 within the docking station. As described herein, the wheels of the scooter 210 contact and grip the inner wheel tracks 1010, 1012 and self-propel along and up the station towards a docking or storage area 1020. Thus, as depicted, the rail section 1000 (e.g., part of docking stations described herein) facilitates the vertical stacking and/or storage of electric scooters within a docking station.

FIGS. 10C and 10D depict a rail section 1030 that is similar to the rail section 1000, except the lower channel includes a real wheel charging port 1035 or connector, which charges the scooter 210 within the docking station.

FIGS. 10E and 10F depict a rail section 1050 having an outer wheel track 1060 for an upper channel, as well as an outer wheel track 1062 for a lower channel. The outer wheel track 1060 of the upper channel also includes a front wheel charging port 1065 or connector, which charges the scooter 210 within the docking station. As described herein, the wheels of the scooter 210 contact and grip (e.g., pushing out on) the outer wheel tracks 1060, 1062 and self-propel along and up the station towards a docking or storage area 1070. Thus, as depicted, the rail section 1050 (part of docking stations described herein) facilitates the vertical stacking and/or storage of electric scooters within a docking station.

FIGS. 10G and 10H depict a rail section 1080 that is similar to the rail section 1050, except the lower channel includes a real wheel charging port 1085 or connector, which charges the scooter 1010 within the docking station.

### Interactions Between Electric Scooters and Charging Stations

As described herein, the disclosed technology can enable electric scooters to interact with docking stations (e.g., “docks”), as well with other docked or stored electric scooters via the docking stations.

For example, as described herein, a docking station can include a rail or channel having terminal ends that are electrically isolated from a charging portion of the rail. These rail sections can be energized by a scooter using a scooter's onboard power. When energized, these rail sections provide power to various ancillary functions of a dock, such as dock identification, communication, data storage (e.g., storing information about how many scooters have entered and exited the dock), and actuation (e.g., moving the location of a locking pin so that a scooter may be removed from the dock). The computing systems described herein can facilitate performing some or all of these functions.

As an example, a constant or time-varying controlled current circuit of an electric scooter is powered by a scooter's battery (where the precise current is measured by the scooter's electronics over time). The numerical value of the current can encode information used by the scooter's electronics to determine factors such as the presence of a dock, identification of a dock, diagnostic information, and other information.

Further, in some cases, many or multiple electric battery-powered scooters can be docked, parked, or stored in a docking station. As described herein, the docking station can include bus bars that are in electrical contact with each scooter's battery charging electronics. The charging electronics can include voltage converters to decrease battery voltage to a safe voltage on the dock bus bars. In some cases, the scooters in a dock communicate via wireless components with other scooters (or with the docking station) to negotiate charge balancing from scooters with excess battery charge (e.g., high charge amounts) to scooters with low battery charge (e.g., low charge amounts). Thus, scooters with excess charge can supply current or charge to the dock bus bars, and scooters with low battery charge use that current to charge their batteries.

Thus, in some implementations, an electric scooter charges another electric scooter via the bus bars of a docking station. The docking station can identify scooters having excess charge, and, when they are docked, cause these scooters to discharge to the dock bus. The dock bus then provides the excess charge received from the scooters to other scooters identified as having low battery charge.

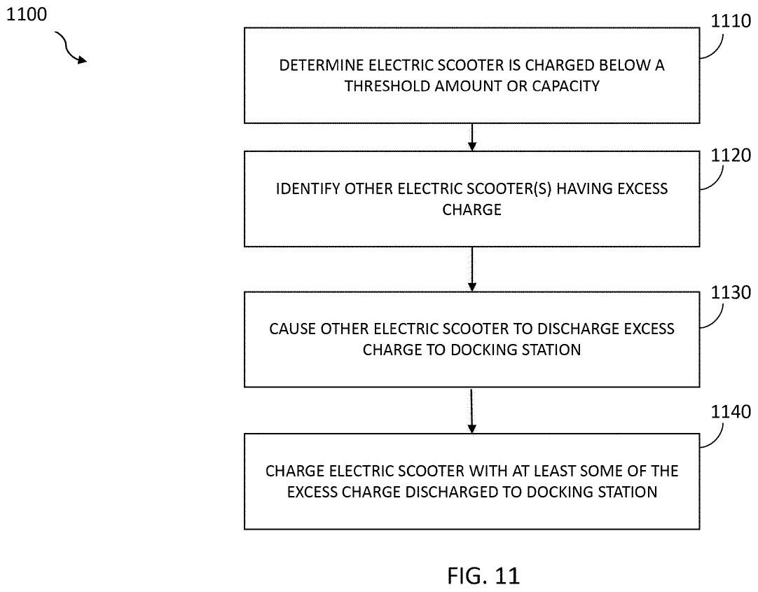

FIG. 11 is a flow diagram illustrating a method 1100 for charging an electric scooter within a docking station. Aspects of the method 1100 may be performed by the docking station and, accordingly, is described herein merely by way of reference thereto. It will be appreciated that the method 1100 may be performed on any suitable hardware.

In operation 1110, the docking station determines or detects that an electric scooter docked with the docking station is charged below a threshold capacity. For example, the docking station may determine that electric scooter is charged at 20 percent capacity, which is below a minimum or threshold capacity for providing the scooter to a user of a scooter share service.

In some embodiments, the docking station may initiate the charging of electric scooters (e.g., perform a charge balancing action) after a pre-determined number of electric scooters (e.g., two or more) are stored within the electric scooter docking station. The number of scooters can be based on the storage capacity of the docking station, the frequency of use of the docking station, the frequency of scooter returns to the docking station, the expected or predicted frequency of use of the docking station, and so on.

In some embodiments, the docking station can seek to initiate charging of electric scooters in response to detecting that an electric scooter has been with a user for a pre-determined period of time. For example, the docking station can detect a scooter has been out (in use) for a certain period of time (e.g., an hour), and initiate charging or charge balancing, as that period of time is indicative of a low battery of the scooter.

In operation 1120, the docking station (or the low charge scooter) identifies one or more other scooters within the docking station having excess charge capacity. For example, the docking station determines that the electric scooter has a battery that is 90 percent full, well over a threshold capacity for providing the scooter to a user (e.g., the threshold being 50 percent or higher).

In operation 1130, the docking station (or the low charge scooter) causes the electric scooter to discharge some excess capacity to the station. For example, the docking station communicates with the scooter and request the scooter provide some excess charge to the station via the electric bus bars of the rail of the docking station.

In operation 1140, the station charges the low charged electric scooter. For example, the station, via the bus bars of the rail, causes the excess charge received from the electric scooter to charge the battery of the electric scooter, also connected via the bus bar of the rail of the station.

Thus, in some implementations, the docking station can facilitate the charging of scooters by other scooters. In such cases, a docking station can be a simple structure that does not have its own power source or connection to the electric grid, while still providing communication and charging functions to scooters docked within the station, among other benefits.

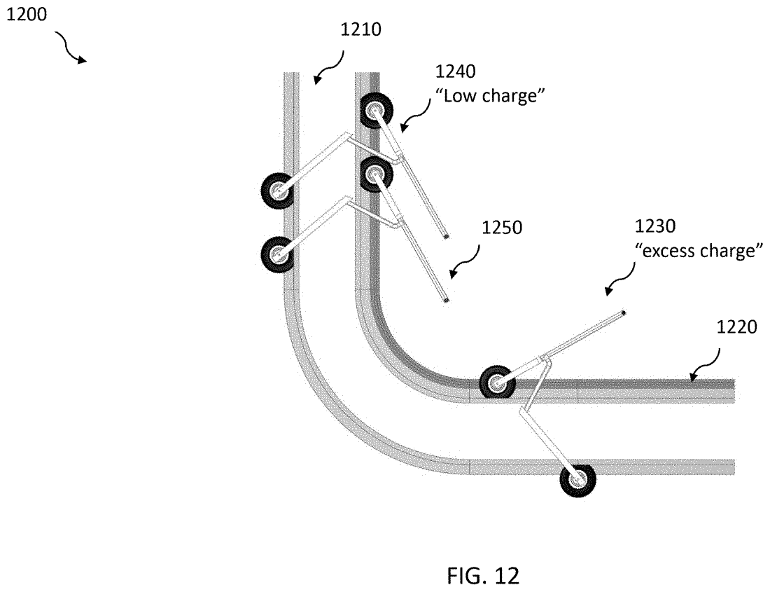

FIG. 12 is a diagram illustrating charge balancing of electric scooters within a docking station 1200. The docking station 1200 includes a channel 1210 and rail 1220 having bus bars that electrically connect to electric scooters 1230, 1240, and 1250 docked within the docking station 1200. The docking station 1200 can determine that the electric scooter 1230 is currently storing extra or excess charge (e.g., its battery is charged above a certain threshold capacity, such as ˜80 percent full). The docking station 1200 also determines that electric scooter 1250 has a low charge (e.g., its battery is under a minimum threshold of ˜50 percent full).

Thus, the docking station 1200 can perform various processes, as described herein, to balance the overall charge capacity of the scooters within the station 1200. For example, via the method described herein, the docking station can cause the electric scooter 1230 to discharge its battery, providing charge to the other electric scooters 1240 1250 via the bus bars of the rail 1220, until all three scooters 1230, 1240, 1250 are charge balanced (e.g., all within a certain range of charge).

As another example, given that electric scooter 1240 is in front of the other scooters, the docking station can cause the electric scooter 1230 to discharge to the docking station, and provide the charge (or most of the charge) to the electric scooter 1230, as it will be dispensed before the other electric scooter 1250 that is also charged below the threshold charge for use. Thus, in some cases, the docking station can balance the charging of scooters based on their current charge capacities or levels of charge, as well as their position within the docking station.

In some implementations, the docking station can be mobile or otherwise configured to be movable or transportable (e.g., a pop-up docking station). For example, the docking station can be part of a trailer. The trailer can have a ramp on one or more sides, with one or more rails (as described herein) that capture the scooters and guide the scooters into and through the docking station. Further, as described herein, the rails can facilitate charging of the scooters. In some cases, the trailer can include a battery or other power source to enable charging of the scooters when other sources of energy (e.g., solar panels or small wind turbines) are unavailable in order to opportunistically charge the battery and scooters within the station.

Any or all docking stations described herein may utilize the priority charging of multiple scooters within a station. In some cases, the docking station uses micro-inverters to communicate the priority information and control the charging of scooters within the station. For example, the rail 120 can include multiple segments, where each segment of the rail 120 includes a micro-inverter that converts AC to rail DC voltage. When the energy source is a solar source, the station utilizes switching, such that the station uses energy from associated solar panels to charge only scooters next available for use by users via the station. Thus, only scooters connected to segments having a switched voltage (from AC to DC) can receive charge via solar panels providing energy to the station. In doing so, the station enables scooters soon to be provided to users (e.g., scooters near the exit of a docking station) to be charged by solar panels first, in order to ensure they are charged before other scooters within the docking station.

### Example Embodiments of the Disclosed Technology

In some embodiments, an electric scooter docking station can perform a method for charging an electric scooter stored within the electric scooter docking station, including determining a battery of a first electric scooter stored within the electric scooter docking station has a current charge amount that is below a threshold charge amount for dispensing electric scooters to riders, identifying a second electric scooter stored within the electric scooter docking station that has a battery having a current charge amount above the threshold amount for dispensing scooters to riders, causing the second electric scooter to discharge an excess charge amount from the battery of the second electric scooter to the electric scooter docking station, and charging the battery of the first electric scooter using the excess charge amount discharged from the battery of the second electric scooter to the electric scooter docking station.

In some cases, the electric scooter docking station includes at least one bus bar connected to the first electric scooter and the second electric scooter when the first electric scooter and the second electric scooter are stored within the electric scooter docking station, where the electric scooter docking station transfers charge from the second electric scooter to the first electric scooter via the at least one bus bar.

In some cases, the first electric scooter is positioned in front of the second electric scooter within the electric scooter docking station.

In some cases, the electric scooter docking station determines a battery of a first electric scooter stored within the electric scooter docking station has a current charge amount that is below a threshold charge amount for dispensing electric scooters to riders in response to a charge balancing action performed by the electric scooter docking station initiated after a pre-determined number of electric scooters are stored within the electric scooter docking station.

In some cases, the electric scooter docking station determines a battery of a first electric scooter stored within the electric scooter docking station has a current charge amount that is below a threshold charge amount for dispensing electric scooters to riders in response to detecting the first electric scooter has been with a user for a pre-determined period of time.

In some cases, the electric scooter docking station, the first electric scooter, and the second electric scooter are part of a scooter sharing network that provides scooters to the riders at a specific geographic location.

In some embodiments, a docking station can accommodate three-wheel scooters (e.g., scooters having two front wheels). For example, a docking station that dispenses electric scooters can include two upper channels each configured to receive a front wheel of an electric scooter, a lower channel configured to receive a rear wheel of the electric scooter, where the two upper channels are positioned with respect to the lower channel in a configuration that stores electric scooters within the docking station at an angle with respect to the ground, and a charging rail that contacts a charging port of the electric scooter when the scooter is docked within the apparatus and provides charge to an electric battery of the electric scooter.

As another example, a docking station can dispense electric scooters by positioning multiple electric scooters within multiple channels of the docking station, where the multiple channels are configured to receive wheels of the electric scooters and provide charge to the electric scooters via charging rails within the multiple channels and where the multiple channels include at two distinct channels configured to receive two front wheels of a three-wheel electric scooter, and facilitating self-propelled movement of the multiple electric scooters within the multiple channels of the docking station from an entry portion of the docking station to an exit portion of the docking station.

Thus, in various embodiments, a docking station provides for efficient storage of electric scooters while also charging the scooters when docked within the docking station.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations may perform routines having blocks, or employ systems having blocks, in a different order; and some processes or blocks may be deleted, moved, added, subdivided, combined, and/or modified to provide alternative or subcombinations. Each of these processes, message/data flows, or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the methods and system provided herein can be applied to other systems, not necessarily the system described above. The elements, blocks and acts of the various implementations described above can be combined to provide further implementations.

Any patents, applications and other references noted above, including any that may be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

I/We claim:

1. A docking station that dispenses electric scooters, the docking station comprising:
two upper channels each configured to receive a front wheel of an electric scooter;
a lower channel configured to receive a rear wheel of the electric scooter,
wherein the two upper channels are positioned with respect to the lower channel in a configuration that stores electric scooters within the docking station at an angle with respect to the ground; and
a charging rail that contacts a charging port of the electric scooter when the scooter is docked within the apparatus and provides charge to an electric battery of the electric scooter.

2. The docking station of claim 1, wherein each of the two upper channels includes a V-shaped groove configured to receive a guiding peg of the electric scooter and maintain a position the electric scooter proximate to the charging rail when the guiding peg is disposed within the V-shaped groove of the upper channel.

3. The docking station of claim 1, wherein the charging port is part of a guiding peg of the electric scooter that is configured to maintain a position of the electric scooter proximate to the charging rail when the guiding peg is disposed within one of the upper channels or the lower channel.

4. The docking station of claim 1, wherein the charging rail is part of at least one of the upper channels of the docking station.

5. The docking station of claim 1, wherein the charging rail is part of the lower channel of the docking station.

6. The docking station of claim 1, wherein the charging rail includes rolling contacts that are positioned on the charging rail to maintain contact with the charging port of the electric scooter as the electric scooters travels through the docking station.

7. The docking station of claim 1, wherein the charging rail includes a contact plunger that contacts a contact pad of the electric when the electric scooter is docked within the docking station.

8. A method of dispensing an electric scooter to a user via a docking station that stores electric scooters, the method comprising:
positioning multiple electric scooters within multiple channels of the docking station,
wherein the multiple channels are configured to receive wheels of the electric scooters and provide charge to the electric scooters via charging rails within the multiple channels, and
wherein the multiple channels include at two distinct channels configured to receive two front wheels of a three-wheel electric scooter; and
facilitating self-propelled movement of the multiple electric scooters within the multiple channels of the docking station from an entry portion of the docking station to an exit portion of the docking station.

9. The method of claim 8, wherein the self-propelled movement of the multiple electric scooters within the multiple channels of the docking station from an entry portion of the docking station to an exit portion of the docking station includes rotating wheels of the electric scooters to provide opposing forces to one another and to grip the multiple channels of the docking station.

10. The method of claim 8, wherein the self-propelled movement of the multiple electric scooters within the multiple channels of the docking station from an entry portion of the docking station to an exit portion of the docking station includes rotating wheels of the electric scooters to provide opposing forces to one another and grip the multiple channels of the docking station, such that the multiple electric scooters travel in a vertical direction within the docking station.

11. The method of claim 8, wherein the multiple channels provide charge to the electric scooters via rolling contacts positioned on the charging rails and configured to be coupled with contact pads of the electric scooters when the electric scooters travel within the docking station.

12. The method of claim 8, further comprising:
causing the multiple electric scooters to move through a cleansing area of the docking station that is located between the entry portion of the docking station and the exit portion of the docking station.

13. A non-transitory computer-readable medium whose contents, when executed by an electric scooter docking station, causes the electric scooter docking station to perform a method for charging an electric scooter stored within the electric scooter docking station, the method comprising:
determining a battery of a first electric scooter stored within the electric scooter docking station has a current charge amount that is below a threshold charge amount for dispensing electric scooters to riders;
identifying a second electric scooter stored within the electric scooter docking station that has a battery having a current charge amount above the threshold amount for dispensing scooters to riders;
causing the second electric scooter to discharge an excess charge amount from the battery of the second electric scooter to the electric scooter docking station; and
charging the battery of the first electric scooter using the excess charge amount discharged from the battery of the second electric scooter to the electric scooter docking station.

14. The non-transitory computer-readable medium of claim 13, wherein the electric scooter docking station includes at least one bus bar connected to the first electric scooter and the second electric scooter when the first electric scooter and the second electric scooter are stored within the electric scooter docking station; and
wherein the electric scooter docking station transfers charge from the second electric scooter to the first electric scooter via the at least one bus bar.

15. The non-transitory computer-readable medium of claim 13, wherein the first electric scooter is positioned in front of the second electric scooter within the electric scooter docking station.

16. The non-transitory computer-readable medium of claim 13, wherein the electric scooter docking station determines a battery of a first electric scooter stored within the electric scooter docking station has a current charge amount that is below a threshold charge amount for dispensing electric scooters to riders in response to a charge balancing action performed by the electric scooter docking station initiated after a pre-determined number of electric scooters are stored within the electric scooter docking station.

17. The non-transitory computer-readable medium of claim 13, wherein the electric scooter docking station determines a battery of a first electric scooter stored within the electric scooter docking station has a current charge amount that is below a threshold charge amount for dispensing electric scooters to riders in response to detecting the first electric scooter has been with a user for a pre-determined period of time.

18. The non-transitory computer-readable medium of claim 13, wherein the electric scooter docking station, the first electric scooter, and the second electric scooter are part of a scooter sharing network that provides scooters to the riders at a specific geographic location.

19. The non-transitory computer-readable medium of claim 13, wherein the first electric scooter and the second electric scooter contact a charging rail of the electric scooter docking station when stored within the electric scooter docking station.

20. The non-transitory computer-readable medium of claim 13, wherein the first electric scooter and the second electric scooter contact a charging rail of the electric scooter docking station when moving through the electric scooter docking station.
